(19) United States
(12) Patent Application Publication
(10) Pub. No.: US 2009/0035419 A1
(43) Pub. Date: Feb. 5, 2009

(54) Hermetically-sealed pre-packaged meal tray and accompanying food for pets

(76) Inventors: Logan Woods, Riverside, CA (US); Gloria Woods, Riverside, CA (US)

Correspondence Address: LAW OFFICES OF ANDREW SCHROEDER, P.O. Box 6731, Santa Maria, CA, 93454, US

(21) Appl. No.: 11/888,224

(22) Filed: Jul. 30, 2007

(51) Int. Cl. B65D 81/00; A23L 1/302; B65D 81/34; A23L 1/304

(52) U.S. Cl. 426/72; 426/107; 426/115; 426/74; 426/87

(57) ABSTRACT

A hermetically sealed, pre-packaged food tray and accompanying food for domestic pets includes a tray with a plurality of compartments and a seal. The tray has a top side, a bottom side and a lip. The plurality of compartments are used for housing the food intended for the domestic pets. The seal is a planar member which is disposed around the tray.

### FIELD OF THE INVENTION

The present invention relates with pet food and other attendant pet-related products.

### BACKGROUND OF THE INVENTION

Many pet owners are faced with the dilemma of feeding their pets “dog food” or “cat food” which is unpleasant and smells the same. When forced to choose, most pets invariably prefer to eat the same food as their owners: fresh, hot, and thoroughly cooked which looks as pleasant as it tastes. As a result, most pets simply ignore their “pet food” and stare wistfully at their owners as they eat the more agreeable food.

If pet owners feed their pets regular pet food they are faced with the possibility of giving them dried or wet food full of unhealthy preservatives and fillers. Moreover, many of the chemicals and other ingredients can be harmful to the pets and cause severe health risks.

On the other hand, if pet owners feed their pets regular “people food”, they risk feeding their pets food not intended to be used with their specific digestive tract. Moreover, some foods such as chocolate can prove lethal to many pets. In addition, the calorie and carbohydrate-rich foods of “people food” can be so addictive to many pets that they can gain a lot of weight and begin to experience similar obesity-related health risks: cancer, diabetes, high cholesterol levels, heart attacks, heart disease, etc.

One solution would be to provide pets wholesome, nutrient-enriched organic foods specially prepared for domestic pets. However, given the nature of these foods for spoilage, packaging is a concern. Most pet foods are either canned or heavily laden in preservatives to prevent spoilage. Or alternatively, these foods may need to be microwaved which would require a special container for such use.

Another solution for various pet-related diet issues is portion control. Rather than feeding a pet off a user's plate it would be desirable for a pet to be issued a daily pre-determined portion specifically calibrated for that pet's caloric and nutritional needs. By setting limits on the portions to which a pet is given, the issue of pet-obesity and its attendant health risks would be eliminated.

Therefore, what is clearly needed in the marketplace is a hermetically-sealed, pre-packaged and microwavable, oven, and stove-top tray specifically designed for pets. Included within this tray should be various pre-determined foods specifically chosen for the nutritional and caloric needs of a specific domestic pet.

### SUMMARY OF THE INVENTION

It is an object of the present invention to provide a healthy, pre-packaged food tray for domestic pets capable of preserving organic foods. This pre-packaged food tray may contain in some embodiments a detachable compartment filled with yogurt.

It is an object of the present invention to provide a microwaveable, oven, and stove-top tray for the purpose of providing pets foods which may be easily heated and thoroughly cooked. By providing domestic pets with cooked food which resembles the same type of food which their owners eat, the domestic pets will be able to enjoy their food while eating according to their nutritional needs.

It is an object of the present invention to provide a pre-packaged meal with tray for pets which includes a special ridged bottom tray which enables a domestic pet to easily eat the food therein. This enhanced shape conforms to the unique contours of the snout or face of the domestic pet thus enabling for better feeding experience.

It is an object of the present invention to provide a specifically calibrated meal with specific nutritional and vitamin needs for various pets. These meals should also be specifically made for the caloric needs of the individual pets. Moreover, in some embodiments herbs may be supplemented into the meals in order to enhance the overall nutritional value of the pre-packaged meals.

### BRIEF DESCRIPTION OF THE DRAWING FIGURES

FIG. 1 is a perspective view of a preferred embodiment of the present invention.

FIG. 2 is a plan view of a preferred embodiment of the present invention.

FIG. 3 is a frontal view of a preferred embodiment of the present invention.

FIG. 4 is a plan view of a preferred embodiment of the present invention.

FIG. 5 is a side view of a preferred embodiment of the present invention.

FIG. 6 is a side view of a preferred embodiment of the present invention.

### DESCRIPTION OF PREFERRED EMBODIMENTS

According to a preferred embodiment of the present invention, a unique apparatus is used to provide domestic pets with fresh, flavorful, and healthy foods in a hermetically-sealed pre-packaged container wherein the tray is specifically contoured to the contours of their snout to enable easier feeding. The apparatus is described in enabling detail below.

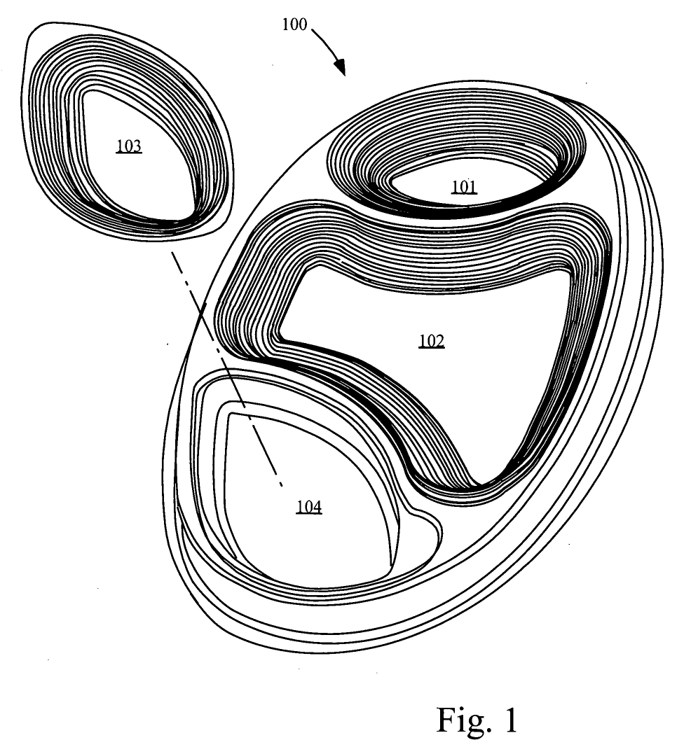

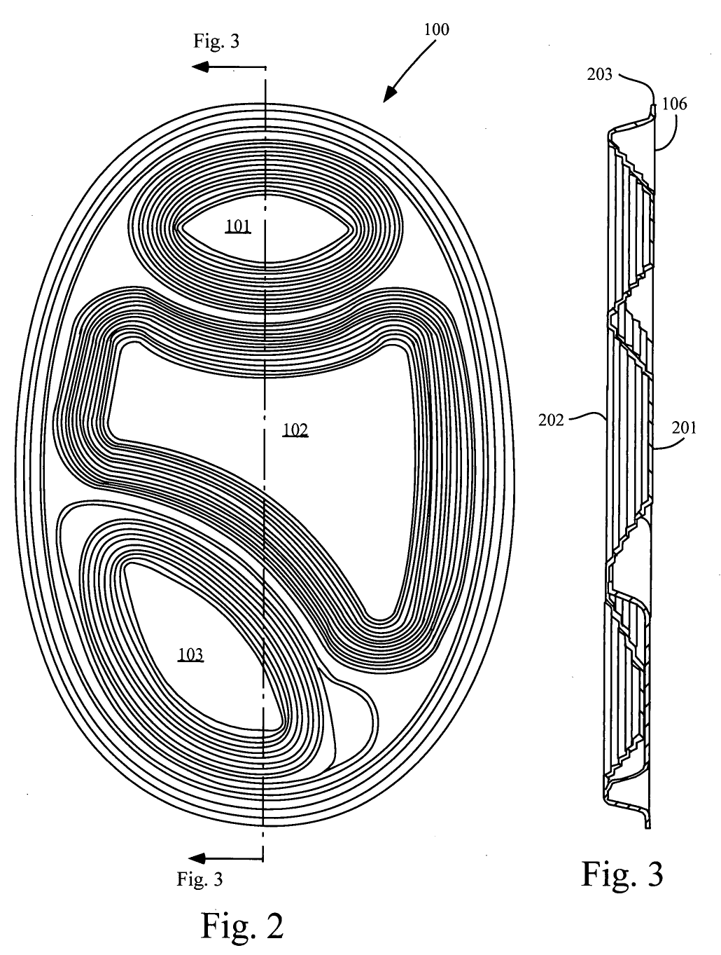

FIG. 1 illustrates a preferred embodiment of the present invention. A hermetically sealed pre-packaged meal in a food tray 100 for domestic pets includes: a tray 100 with a plurality of compartments 101, 102, 104 and a seal 106. The tray having a top side 201 and a bottom side 202 and a lip 203. The plurality of compartments are used for housing the food intended for the domestic pets.

The seal 106 is a planar member or article disposed on the top side of the tray by affixing with the lip of the tray. In some preferred embodiments the seal is wrapped completely around the tray in order to ensure complete freshness. The seal is made of a transparent sheet of polyethylene, polyolefin or similar material. The seal is well known in the art. It should be noted here that in some preferred embodiments the tray may be vacuum-sealed in order to better ensure its freshness.

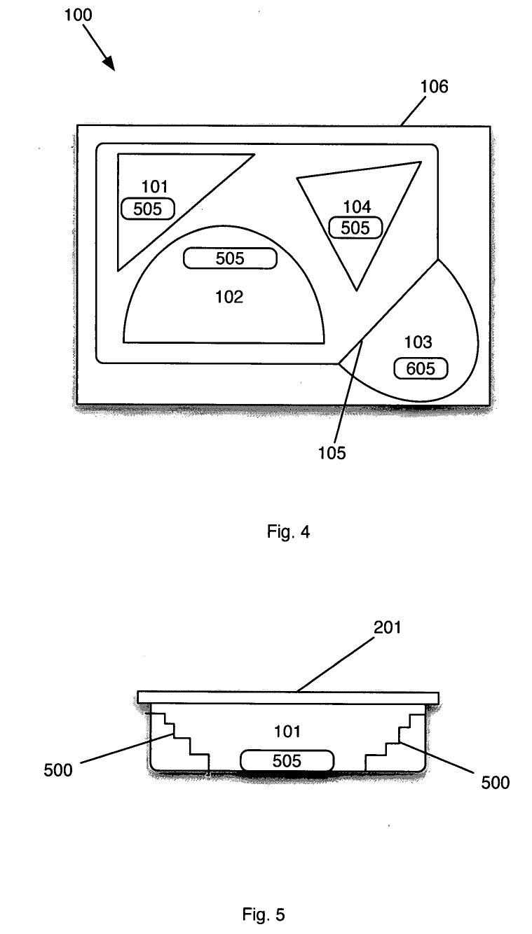

FIG. 4 also illustrates a preferred embodiment wherein the tray further incorporates a detachable compartment 103. The detachable compartment is fused with the lip 203 of the tray through a perforated seam 105.

In some preferred embodiments this detachable compartment is made detachable through perforated holes. In other preferred embodiments the seam could be a continuous indentation intended to make the compartment easily detachable from the tray.

Moreover, in some preferred embodiments the detachable compartment is not affixed to the tray, but is accompanied with the tray. This detachable compartment is sized to mate with a corresponding compartment on the tray such that there is an interference fit. In other words, the detachable compartment snaps onto (or into) the corresponding compartment on the tray. Or, in other preferred embodiments the detachable compartment may just be a separate compartment altogether which is simply affixed to the tray through adhesives or other fastening means. The possibilities are endless.

The purpose of the detachable compartment is to house yogurt 605 in some preferred embodiments. Since it may not be advisable to microwave the yogurt it is made to be easily detachable from the rest of the tray. Moreover, one of the compartments 101, 102, or 104 may be empty for the purpose of pouring the yogurt from the detachable compartment into the empty compartment.

FIG. 5 illustrate that in some preferred embodiments the tray may further include a stepped ridge 500 disposed on the bottom side of the tray for the purpose of enabling a domestic pet to eat the contents of the tray. The ridge is shaped on the sides of the tray in order to enable a domestic pet to use their snout or nose to better maneuver the food into their mouths. Various food 505 is also depicted in the compartments.

In some preferred embodiments the compartments 101, 102, and 104 may house such foods as herbs, meat, tofu, protein-enriched foods, organic foods, fruits, vegetables, and other vitamin-enriched foods. Moreover, the foods may also be enriched with pre-determined minerals specifically required to various pets. For instance, various trays to be specifically designed for Jack Russells may include Zinc. The possibilities are endless. Also, in some preferred embodiments the foods may be supplemented with various medicines such as medicine for combating tapeworms or fleas.

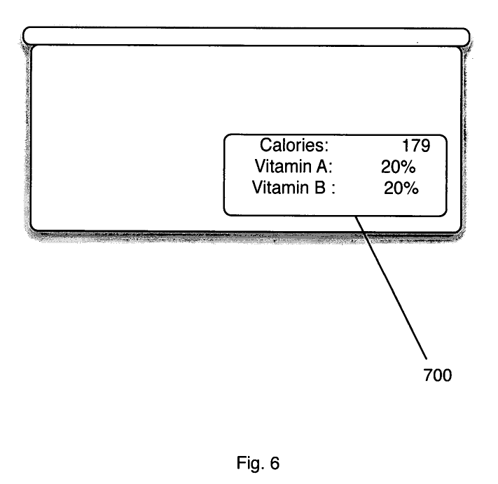

FIG. 6 illustrates another preferred embodiment wherein the tray further comprises a nutritional label. In some preferred embodiments this label may have an adhesive side in order to affix with the side or bottom of the tray. This label may include various indicia such as calories, vitamins, the type of pet the meal is prepared for, etc.

Those skilled in the art will appreciate numerous variations in the present system, configuration and operation that are within the scope of the invention. Those skilled in the art will also appreciate how the principles illustrated in these preferred embodiments can be used in other examples of the invention. A particular reference number in one figure refers to the same element in all of the other figures.

Moreover, It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A hermetically sealed pre-packaged food tray and accompanying food for domestic pets comprising:
a tray with a plurality of compartments, food, and a seal;
the tray having a top side and a bottom side and a lip;
the plurality of compartments are used for housing the food intended for the domestic pets;
the seal is a planar member disposed on the top side of the tray by affixing with the lip of the tray;
the food is disposed in the plurality of compartments.

2. The hermetically sealed pre-packaged food tray and accompanying food for domestic pets of claim 1 further comprising a detachable compartment.

3. The hermetically sealed pre-packaged food tray and accompanying food for domestic pets of claim 2 wherein the detachable compartment is fused with the lip of the tray through a perforated seam.

4. The hermetically sealed pre-packaged food tray and accompanying food for domestic pets of claim 2 wherein the detachable compartment further comprises yogurt.

5. The hermetically sealed pre-packaged food tray and accompanying food for domestic pets of claim 1 further comprising a stepped ridge disposed on the bottom side of the tray for the purpose of enabling a domestic pet to eat the contents of the tray.

6. The hermetically sealed pre-packaged food tray and accompanying food for domestic pets of claim 1 wherein the tray is microwaveable.

7. The hermetically sealed pre-packaged food tray and accompanying food for domestic pets of claim 1 wherein the tray is plastic.

8. The hermetically sealed pre-packaged food tray and accompanying food for domestic pets of claim 1 wherein the seal is disposed completely around the tray.

9. The hermetically sealed pre-packaged food tray and accompanying food for domestic pets of claim 1 further comprising herbs disposed in one of the compartments.

10. The hermetically sealed pre-packaged food tray and accompanying food for domestic pets of claim 1 further comprising organic food in one of the compartments.

11. The hermetically sealed pre-packaged food trayand accompanying food for domestic pets of claim 1 wherein the tray is vacuum-sealed.

12. The hermetically sealed pre-packaged food tray and accompanying food for domestic pets of claim 1 further comprising a nutritional label.

13. The hermetically sealed pre-packaged food tray and accompanying food for domestic pets of claim 1 wherein the tray is adaptable for use with stove tops.

14. The hermetically sealed pre-packaged food tray and accompanying food for domestic pets of claim 1 wherein the tray is adaptable for use with ovens.

15. The hermetically sealed pre-packaged food tray and accompanying food for domestic pets of claim 1 further comprising foods enriched with protein.

16. The hermetically sealed pre-packaged food tray and accompanying food for domestic pets of claim 1 which further comprise foods enriched with vitamins.

17. The hermetically sealed pre-packaged food tray and accompanying food for domestic pets of claim 1 further comprise foods enriched with a plurality of pre-determined minerals.

18. The hermetically sealed pre-packaged food tray and accompanying food for domestic pets of claim 1 further comprising foods enriched with anti-oxidants.

19. The hermetically sealed pre-packaged food tray and accompanying food for domestic pets of claim 1 further comprising foods enriched with medicine.

20. The hermetically sealed pre-packaged food tray and accompanying food for domestic pets of claim 1 wherein the seal is comprised of polyethylene.
